(19) United States
(12) Patent Application Publication
(10) Pub. No.: US 2009/0013574 A1
(43) Pub. Date: Jan. 15, 2009

(54) Lightweight assistance requesting plackard

(76) Inventor: David E. Palmer, Mountain Center, CA (US)

Correspondence Address: I. Michael Bak-Boychuk;Attorney at Law, P.O. Box 32501, Long Beach, CA, 90832, US

(21) Appl. No.: 11/827,181

(22) Filed: Jul. 11, 2007

(51) Int. Cl. G09F 15/00; G08B 5/00

(52) U.S. Cl. 40/610; 40/559

(57) ABSTRACT

A reinforced fabric panel is provided with a peripheral sheath in which a resilient, thin-walled inflatable tube is deployed. When inflated the tube confined in the peripheral sheath erects from a folded state and then stretches the panel to its full plan dimensions to display an emergency message that may be illuminated by a set of strobe lights attachable to the panel edges. The stretched panel is useful as a signaling placard both on land and on the sea surface, restrained against wind either by locally found objects or by the ballast weight of the water that is trapped in the sheath.

### BACKGROUND OF THE INVENTION

1. Field of the Invention

The present invention relates to emergency signaling placards, and more particularly to an expandable folded membrane having an inflatable tube confined within a peripheral sheath formed therein to expanded by inflation of the tube the folded membrane for displaying periodically illuminated assistance message imprinted thereon.

2. Description of the Prior Art

Those engaged in outdoor activities, and particularly those in solitary adventures like setting out to sea in small vessels or sailing craft, remote cross-country hiking, or solitary mountain climbing, are constantly aware of the potential perils that can befall them in their solitude which may then require their search and assistance by others. As result, various signaling devices like flares, portable radio beacons or light signaling structures are all part of any equipment complement of those so engaged.

In each instance, however, these signaling devices are either self consuming, and therefore useful only during the first instance when the solitary adventurer decides and/or is able to set them off, or require heavy storage batteries of sufficient capacity, and therefore weight, to be useful throughout any search period. Of course, these same weight and bulk aspects increase the burden on the solitary adventurer often at the expense of other life sustaining equipment and supplies.

In the past various signaling mechanisms have been devised which, to conserve weight and bulk, erect by inflation a mast or post onto which a distress flag may then be deployed, as exemplified by the teachings of U.S. Pat. No. 4,416,212 and 4,475,475 both issued to Howard and U.S. Pat. No. 5,634,427 to Rollins. Alternatively, helium inflated, radar-reflecting, tethered balloons were proposed as in U.S. Pat. No. 4,697,706 to Schaller and various erectable roadside emergency flag kits, like those described in U.S. Pat. No. 5,560,491 to Romaniuk et al. and U.S. Pat. No. 2,886,983 to Budd, were proposed for the automobile traveler.

While suitable for the purposes intended, each of the foregoing either entail substantial equipment complements or are directed to a limited function like signaling a roadside emergency to the other road traffic and the like, limitations and attributes that are of little benefit to the minimalistic but widely effective signaling requirements of a solitary venturer traversing remote sites. Those minimal signaling placards, like the one described in U.S. Pat. No. 5,724,910 to Annesley et al. are all generally limited in their function, e.g., signaling by an under-the-door edge projecting sign to the assisting emergency personnel the remaining occupants in a multi-dwelling structure.

Accordingly, most of the prior art is focused on signaling methods useful in dense settings in which the traffic patterns of others determine the particular solution. In contrast, the solution that is useful to a solitary venturer crossing a remote wilderness must, of necessity, be focused both on its minimal bulk and weight, i.e., portability, and also its effectiveness over large distances, particularly since it is the current practice now to search remote wilderness or sea surfaces by of loose search grids from an airplane.

In the foregoing remote settings very light weight, packaging compliance and therefore convenient portability, of a signaling device are all attributes that will insure its use particularly if the device is also useful for other, secondary functions like rain collection, protection from the elements, and the like. Where these attributes are all included with high visibility characteristics both during day and also at night a particularly useful device is obtainable that shortens the emergency airborne search which both increases chances of survival and also conserves fuel and manpower use.

Those signaling prior art devices that have focused on searching from an airborne search pattern, like that described in the Patent Application Publication US 2005/0045088 by Martin, follow the earlier structural examples of an automatically inflatable raft in which the periphery is inflated to stretch a flexible panel therebetween by releasing compressed gas stored in a cartridge. While suitable for the purposes intended, this type of structure relies in its deployment on the continuing inflation integrity of a robust peripheral beam. Of course, the skin thickness of this inflatable beam, of necessity, needs to be quite rugged and thick if land use, with the various sharp projections that are usually encountered thereon, is also contemplated. Thus devices of this kind are generally too heavy, and also too bulky when collapsed, for the minimalistic concerns of a solitary venturer.

A highly portable, light weight, reliable and highly discernable signaling signaling mechanism is therefore extensively desired and it is one such mechanism that is described herein.

### SUMMARY OF THE INVENTION

Accordingly, it is the general purpose and object of the present invention to provide a light weight, conveniently foldable signaling panel provided with a peripheral sheath in which a thin-walled inflatable hose is deployed and to which light weight strobe lights are secured.

Other objects of the invention are to provide a light weight signaling panel unfolded to its full dimensions by inflating a thin-walled elastic hose in a peripheral sheath thereof.

Yet further objects of the invention are to provide a light weight, compactly folded, signaling device which is easily unfolded by embouchure inflation to display a strobe light illuminated emergency message.

Briefly, these and other objects are accomplished within the present invention by providing a generally rectangular thin fabric panel folded over at its edges to form a peripheral sheath in which a thin-walled elastomeric air-impervious inflatable tube is deployed. The open end of the tube extends to the exterior of the sheath for convenient embouchure inflation and closure and once erected by inflation the tube then stretches the fabric panel from its folded storage arrangement to display an emergency message imprinted thereon. In this manner the fragile, easily damaged membrane forming the inflatable tube, both when flaccid and in its inflated state, is fully enclosed and protected by the fabric forming the peripheral sheath.

By selecting an easily folded thin, but rugged, fabric like that sold under the mark or style Silk-iene #FS1030 silicone coated nylon ripstop fabric, sold by American Home & Habitat, Inc., Box 86, Rural Route 4, Squires, Mo. 65755, [www.ahh.biz], or its equivalents, this combination can be easily folded into a small compliant packet that is easily stored right on the venturer's person. These same compliant and generally penetration resistant attributes thereof are then also useful as a protective shield or cover over an injury while the solitary venturer looks for an appropriately visible search location.

It will be appreciated that the inflation tensions of the erected tube walls will be generally confined by the limits of the rectangular panel planform as defined by the peripheral sheaths, with some convolving at each corner thereof. In this manner excess fabric is provided at each sheath corner that is then useful for attaching a miniaturized strobe light like the self-contained, submersible strobe lights sold by PELICAN, INC., 23215 Early Ave., Torrance, Calif. 90505 under the mark or style Mini Flasher 2130 LED, each including its own storage battery which, by virtue of the intermittent or strobed use can remain turned on and operating for long periods of time while the search continues.

The excess sheath corner fabric is also available to affix restraining straps that may be tied to spikes or pegs to hold the erected placard on the ground, or that may be weighted down by any locally available objects. When deployed as result of an emergency at sea one of the corner straps may be tied to the person of the user with the inflated periphery assuring a stretched panel display on the water surface.

Thus either on land or when used to signal an emergency from its floating position on a water surface the loose material of the peripheral sheath is used to an advantage and it is the same sheath that also protects the fragile elastomeric wall membrane of the inflatable tube, both prior to and after inflation. In this manner light weight elements can be rendered useful in a foldable structure that will be exposed to the various hazards associated with remote locations.

Preferably the panel fabric is colored in an easily discernable color like yellow with the message characters thereon in International Orange, or a similar color scheme that contrasts well against the natural environment. To enhance night searching that is frequently carried out with the aid of infrared night vision devices one or more of the strobe lights may be operative in the infrared spectrum, such as that also sold by Pelican, Inc. under the mark or style Mini Flasher 2130IR LED. In this manner a light, compactly folded emergency signaling assembly is provided that is useful in a wide range of settings and that is conveniently carried as a compliant package that conforms to a person.

### BRIEF DESCRIPTION OF THE DRAWINGS

FIG. 1 is a perspective illustration of the inventive emergency signaling placard in its deployed form supported on a surface of water;

FIG. 2 is yet another perspective illustration, separated by parts, of the inventive signaling placard in the course of its deployment;

FIG. 3 is a perspective detail view, in partial section, of one corner of the inventive signaling placard in its fully erected expansion;

FIG. 4 is a sectional view taken along line 44 of FIG. 1;

FIG. 5 is a plan view of the inventive signaling placard in its fully extended form; and

FIG. 6 is a further perspective illustration of the inventive signaling placard in its collapsed and folded form.

### DESCRIPTION OF THE PREFERRED EMBODIMENT

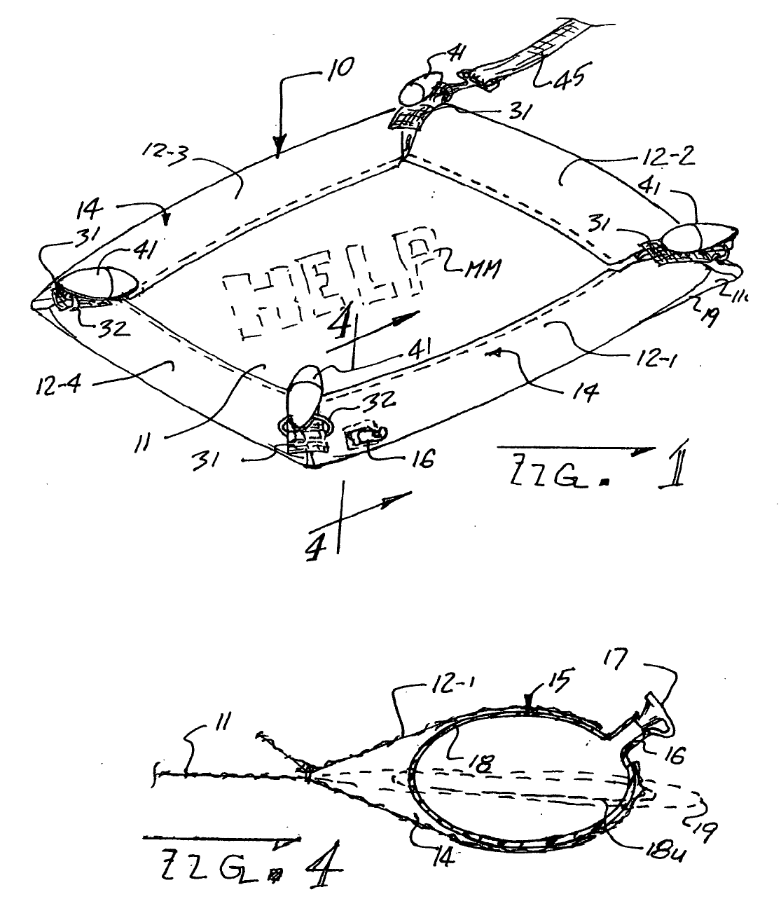

As shown in FIGS. 1 through 4 the inventive signaling placard, generally designated by the numeral 10, comprises a substantially rectangular thin fabric panel 11 having the edge strips 12-1 through 12-4 thereof folded over and affixed proximate their free edges to the subjacent panel surface to form a peripheral envelope or sheath 14 in which an elongate air impervious tube 15 is received. Preferably, tube 15 is formed as a thin-walled elastomeric enclosure of a length equal or just less then the peripheral dimension of sheath 14, with one end of tube 15 extending to the exterior through edge strip portion 12-1 to present an opening 16 conformed for inflation by mouth and provided with a conventional closure shown as a dependent stopper 17.

In its deflated form the wall membrane 18 of the flaccid tube 15 collapses to assume a generally a flat cross section shown by the phantom illustration thereof in FIG. 4 with the wall membrane 18 deflating into a collapsed stack 18u. Of course, the fabric surfaces forming sheath 14, namely the fabric panel 11 and the folded over edge strips 12-1 (through 12-4) fastened to each other along fastening lines 13, assist in this collapse by the weight thereof and also by the crease bias at the peripheral fold crease 19.

In this manner the combination of the fabric panel 11 with the flaccid hose 15 received in the peripheral sheath 14 are biased to form a generally flat configuration that can be folded into a small, but compliant, stack that easily conforms for storage along any body surface of a person. This convenience in folding may also be utilized to protect any injured body areas or, with the aid of straps described in more detail below, to form a sling suspending an injured limb. Of course, these conveniences and adaptations to other purposes are particularly useful to those embarking on solitary adventures.

It will be appreciated that the layered configuration is also particularly effective in protecting thin-walled inflatable structures both after inflation and also when folded. More precisely, by utilizing one of the several thin and light weight fabrics that are currently commercially available which also have extraordinarily rugged attributes against tearing or puncture, like the fabric Silk-iene referred to above, the walls 16 of the inflatable hose 15 are fully protected from inadvertent puncture when stored, during inflation, and thereafter once the desired inflation level is achieved.

Those skilled in the art will appreciate that the foregoing layered configuration allows the use of thin, and therefore light weight and frail, membranes since the inflation level, itself, is self limiting by the confining dimensions of sheath 14. Thus the layered arrangement results in a structure that will protect against tube failure due to inadvertent over-exuberance during inflation, an incident that may occur with some frequency under the stressful circumstances of am emergency.

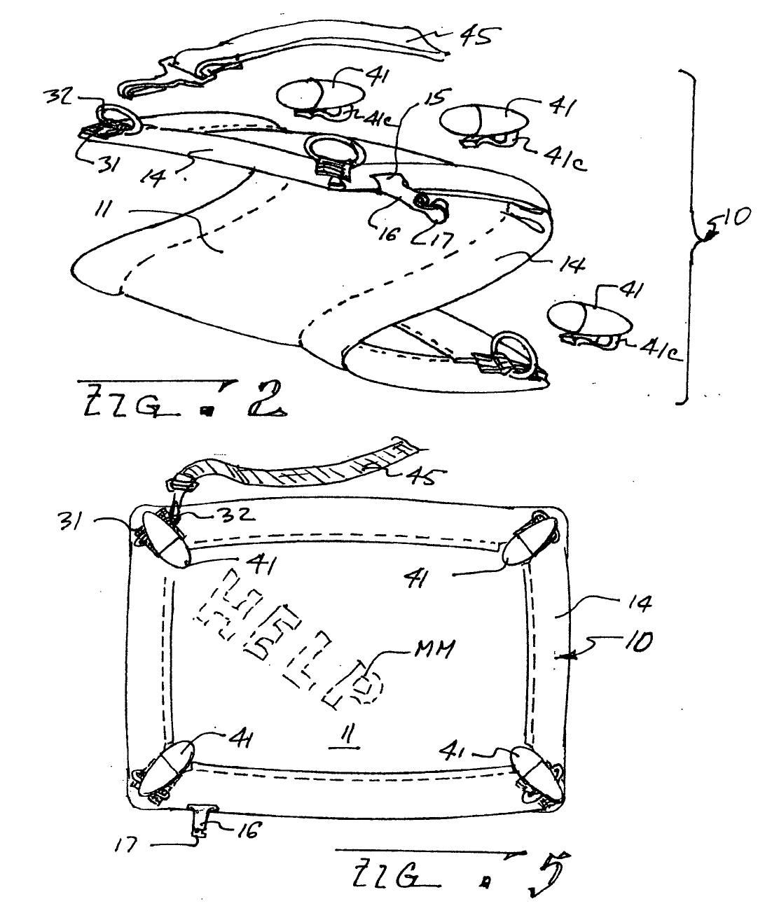

By particular reference to FIG. 3 this captive receipt of the tube 15 within the planform of panel 11, as defined by the edge strips 12-1 through 12-4 combining to form the peripheral sheath 14, resolves itself during inflation in folds 27 in the interior parts of tube membrane 18 at each panel corner. The unrestrained exterior periphery membrane portion of tube 15 thus confined will concurrently take on a rounded bend shape 28 in the course of resolving the membrane stresses during inflation, leaving the outer parts of the panel material forming each panel corner 11c essentially unstressed. This loose material can then be used as attachment surfaces for strap segments 31, each provided with an attachment ring 32. In this manner the fabrication convenience of a rectangular planform is inventively used to advantage for attachment of selected miniature strobe lights 41 like those described above by the mark or style Mini Flasher 2130 LED or Mini Flasher 2130IR LED.

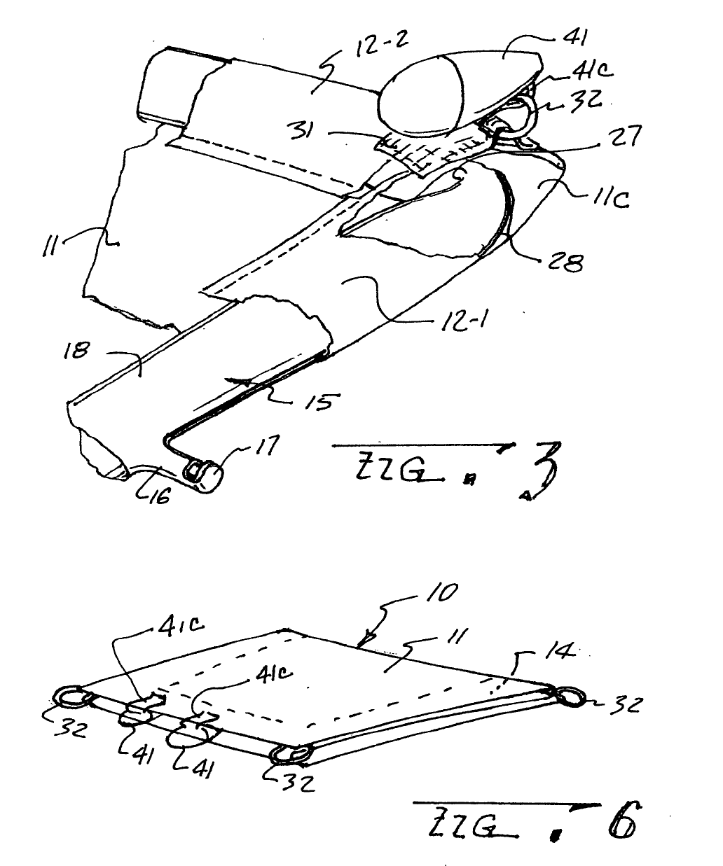

It will be further appreciated, by reference to FIG. 6, that the commercial form of the foregoing miniature strobe lights 41 is usually provided with its own light-weight stored energy source and also with a spring clasp 41c and can therefore be selectively clasped to any fold in the material of panel 11 during storage. This same facility is then useful in engaging attachment rings 32 at each corner, as illustrated in FIG. 5, for periodic illumination of any message MM inscribed on panel 11 once erected by inflation.

Additionally, an adjustable strap 45 is provided with attachment clips 46 at each end conformed to engage one or more of the rings 32 either to tie the inflated panel to the person when floating on water, to assist in forming a sling or injury protecting pad, or to tie that inflated panel to any local structure. Thus the invention provides an effective, light-weight emergency signaling assembly which also avails many additional uses desirable to solitary venturers.

In each instance it is the combined use of light-weight, reinforced fabrics like that exemplified by the fabric sold under the mark or style ‘Silk-iene’ for the panel 11, and therefore sheath 14, that renders the structure rugged and virtually puncture proof to shield the fragile membranes of the elastomeric inflatable tube 15 that obtains all the multiple conveniences of use described above. Moreover, since the excess volume within sheath 14 that surrounds the tube even after inflation is not hermetically closed it will inherently fill with water when deployed as a signal marker in a sea emergency, thus providing a ballast weight keeping the inventive signaling device on the sea surface even in windy environments.

In this manner various uses are obtainable from a device that also serves in its primary function as an emergency signaling device. These multiple uses are obtainable at a minimal weight burden, a feature particularly useful to solitary adventurers that have to carry their own complement of tools and supplies.

Obviously many modifications and variations of the instant invention can be effected without departing from the spirit of the teachings herein. It is therefore intended that the scope of the invention be determined solely by the claims appended hereto.

1. An emergency signaling assembly, comprising:
a generally rectangular fabric panel provided with a plurality of peripheral sheath seaments each defined by folded over edge portions each attached to said panel to define an elongate enclosure open at the ends thereof;
an inflatable elastomeric tube received to extend through the common interior of said peripheral sheath segments, said tube including an inflation opening extending to the exterior between selected adjacent ends of said sheath segments for stretching said panel upon the inflation thereof and thereby provide upon inflation a captive volume defined by the volumetric differential between said tube and the enclosed volume of each said segment; and
strobe light means conformed for attachment to said panel between the ends of said peripheral sheath segments for periodic illumination of said panel.

2. An emergency signaling assembly according to claim 1, wherein:
said strobe light means includes a plurality of strobe lights attachable to the corners of said peripheral sheath in alignment for illuminating said panel.

3. An emergency signaling assembly according to claim 1, wherein:
said tube is limited in the inflated shape thereof by the planform dimensions of said panel stretched by said tube within said peripheral sheath segments.

4. An emergency signaling assembly according to claim 3, further comprising:
a removable closure conformed for sealing said inflation opening.

5. An emergency signaling assembly according to claim 4, wherein:
said panel includes an emergency message inscribed thereon.

6. An emergency signaling assembly according to claim 5, wherein:
said strobe light means includes an infrared emitting strobe light.

7. An emergency signaling assembly according to claim 6, wherein:
said panel fabric comprises puncture resistant fabric.

8. A foldable emergency signaling assemblage, comprising:
a generally rectangular fabric panel having edge portions thereof folded over onto one side of said panel and attached thereto to form in combination therewith a plurality of peripheral sheath segments each forming an elongate enclosure open at the ends thereof;
an inflatable elastomeric tube received in the interiors of said peripheral sheath segments including an inflation opening extending to the exterior between adjacent ends of said sheath segment, the inflated dimensions of said tube being limited by the planform dimensions of said panel, whereby upon the inflation of said tube a captive volume is formed by the volumetric differential between the volume of said tube and the corresponding volume enclosed by each said segment; and
a plurality of strobe lights attachable to the corners of said panel between the adjacent ends of said peripheral sheath segments in alignment for illuminating said panel.

9. A foldable emergency signaling assemblage according to claim 8, wherein:
said panel comprises puncture resistant fabric.

10. A foldable emergency signaling assemblage according to claim 8, wherein:
said plurality of strobe lights includes an infrared emitting strobe light.

11. (canceled)

12. A foldable emergency signaling assemblage according to claim 10, wherein:
said peripheral sheath includes attachment means at the corners thereof.

13. A foldable emergency signaling assemblage according to claim 12, wherein:
said attachment means includes an attachment ring.

14. (canceled)

15. A foldable emergency signaling assemblage according to claim 13, wherein:
said plurality of strobe lights includes an infrared emitting strobe light.

16. A foldable emergency signaling assemblage according to claim 15, wherein:
said strobe lights include attachment clips conformed to engage said attachment ring.
